(19) United States
(12) Patent Application Publication
(10) Pub. No.: US 2015/0122892 A1
(43) Pub. Date: May 7, 2015

(54) RADIO FREQUENCY IDENTIFICATION TAG

(71) Applicant: MUTUAL-PAK TECHNOLOGY CO., LTD., Zhongli City (TW)

(72) Inventors: Po Ching CHEN, Zhongli City (TW); Tzu-Chien HUANG, Zhongli City (TW)

(21) Appl. No.: 14/535,729

(22) Filed: Nov. 7, 2014

(30) Foreign Application Priority Data
Nov. 7, 2013 (TW) 102140560

(51) Int. Cl. G06K 19/077

(52) U.S. Cl. CPC G06K 19/07798; G06K 19/07722
USPC 235/488; 235/492

(57) ABSTRACT

A radio frequency identification tag comprises a chip; a circuit antenna connected to the chip; and a substrate having a front side carrying the chip and the circuit antenna and formed with a scribing portion, wherein the scribing portion overlaps at least one part of the circuit antenna when viewed from a back side of the substrate.

### BACKGROUND OF THE INVENTION

1. Field of the Invention

The present invention relates to identification tags, and more particularly, to a radio frequency identification tag adapted to transmit and receive signals wirelessly.

2. Description of the Prior Art

In recent years, wireless chip devices adapted to transmit and receive signals wirelessly are developed extensively. The wireless chip devices adapted to transmit and receive signals wirelessly are known as radio frequency identification (RFID) tags, RF tags, RF chips, wireless tags, wireless processors, wireless memory, integrated circuit tags, and electronic tags. Radio frequency identification tags are for use in labeling various objects to serve various purposes, such as identification, certification, and tracking.

Radio frequency identification tags have wide applications, including parking fee payment management, highway toll management, and access control surveillance management. Radio frequency identification tags are compact and lightweight, easy and quick to affix, not battery-assisted, and thus highly applicable to vehicles. However, radio frequency identification tags are not immune to problems with use. For instance, vehicular radio frequency identification tags are simply affixed to windshields or vehicular lamps and thus are likely to be stolen and misappropriated. Hence, it is necessary to improve the structures of radio frequency identification tags to solve the aforesaid problem with a view of optimizing their use.

### SUMMARY OF THE INVENTION

In view of the aforesaid problem, that is, radio frequency identification tags are likely to be stolen and misappropriated, the present invention provides a radio frequency identification tag capable of preventing reuse.

An embodiment of the present invention provides a radio frequency identification tag, comprising: a chip; a circuit antenna connected to the chip; and a substrate having a front side carrying the chip and the circuit antenna and formed with a scribing portion, wherein at least one part of the scribing portion overlaps at least a portion of the circuit antenna when viewed from a back side of the substrate.

An embodiment of the present invention provides a radio frequency identification tag, comprising: a chip; a circuit antenna connected to the chip; and a substrate having a front side carrying the chip and the circuit antenna and having at least a scribing portion, wherein the at least one part of the scribing portion overlaps at least a portion of the circuit antenna when viewed from a back side of the substrate, wherein, when the radio frequency identification tag is affixed to an object, the radio frequency identification tag is pressed to cause the substrate to rupture along the scribing portion but without causing the circuit antenna to fail.

An embodiment of the present invention provides a radio frequency identification tag, comprising: a chip; a circuit antenna connected to the chip; and a substrate having a front side carrying the chip and the circuit antenna and formed with a scribing portion, wherein at least one part of the scribing portion overlaps at least a portion of the circuit antenna when viewed from a back side of the substrate, wherein, when the radio frequency identification tag is affixed to an object, the radio frequency identification tag is pressed to cause the substrate to rupture along the scribing portion but without causing the circuit antenna to fail, wherein, when the radio frequency identification tag is peeled from the object, a rupture surface which forms along the scribing portion of the substrate weakens the circuit antenna to cause the radio frequency identification tag to fail.

An embodiment of the present invention provides any one of the aforementioned radio frequency identification tags, wherein the circuit antenna is made of copper.

An embodiment of the present invention provides any one of the aforementioned radio frequency identification tags, wherein the circuit antenna is 10˜30 μm thick.

An embodiment of the present invention provides any one of the aforementioned radio frequency identification tags, wherein the substrate is made of glass.

An embodiment of the present invention provides any one of the aforementioned radio frequency identification tags, wherein the substrate is 0.45˜1.00 mm thick.

An embodiment of the present invention provides any one of the aforementioned radio frequency identification tags, wherein the scribing portion is formed on the back side of the substrate.

An embodiment of the present invention provides any one of the aforementioned radio frequency identification tags, further comprising a protective film affixed to the back side of the substrate to conceal the at least a scribing portion.

An embodiment of the present invention provides a method of operating a radio frequency identification tag. The method comprises the steps as follows: a) providing any one of the aforementioned radio frequency identification tags; b) affixing the radio frequency identification tag to an object; and c) pressing the radio frequency identification tag to cause the substrate to rupture along the scribing portion but without causing the circuit antenna to fail.

The present invention includes a management system in related to radio frequency identification technology wherein any one of the aforementioned radio frequency identification tags are applies there to.

The present invention also includes any other aspects and any other embodiments for solving any other related problems. The aforesaid aspects of the present invention are hereunder described in detail.

### BRIEF DESCRIPTION OF THE DRAWINGS

FIG. 1 is a lateral schematic view of a radio frequency identification tag of the present invention;

FIG. 2 is an exploded view of the structure of the radio frequency identification tag of the present invention;

FIG. 3 is a schematic view of the back side of the radio frequency identification tag of the present invention;

FIG. 4 is a schematic view of the radio frequency identification tag affixed to an external object according to the present invention; and

FIG. 5 is a schematic view of the radio frequency identification tag being removed from the external object according to the present invention.

### DETAILED DESCRIPTION OF THE EMBODIMENTS

The preferred embodiments of the present invention will now be described in greater details by referring to the drawings that accompany the present application. It should be noted that the features illustrated in the drawings are not necessarily drawn to scale. Descriptions of well-known components, materials, and process techniques are omitted so as to not unnecessarily obscure the embodiments of the invention.

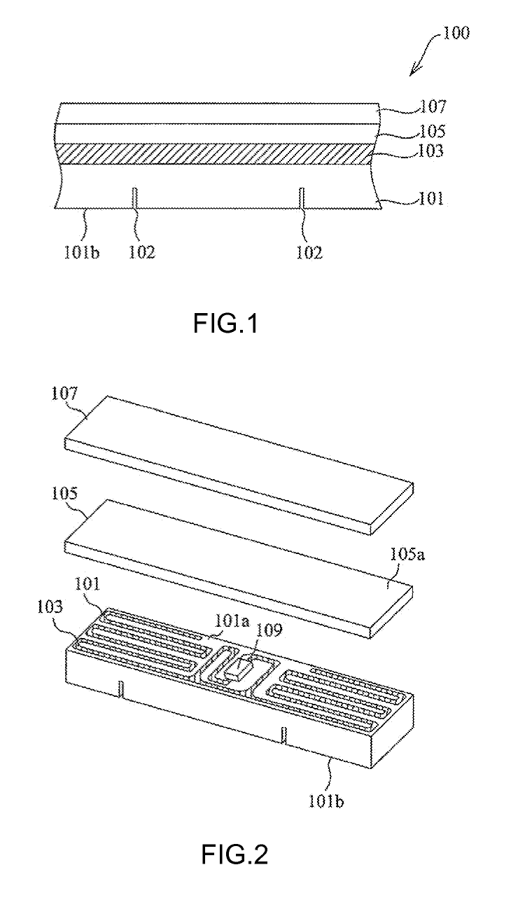

FIG. 1 is a lateral schematic view of a radio frequency identification tag of the present invention. FIG. 2 is an exploded view of the structure of the radio frequency identification tag of the present invention. Referring to FIG. 1 and FIG. 2, according to an embodiment, a radio frequency identification tag 100 comprises a substrate 101, a circuit antenna 103, a chip 109, a cover layer 105, and a release film 107. In this embodiment, the substrate 101 is made of optical glass and is 0.45˜1.00 mm thick. In another embodiment, the substrate 101 is made of any brittle material, such as glass or ceramics, or made of any material suitable for implementation of the functions of the present invention, wherein the required thickness of the substrate 101 depends on the characteristics of the material. To prevent reuse, the substrate 101 comprises at least one scribing portion 102 formed on the substrate 101. According to the embodiment depicted in FIG. 2, the scribing portion 102 is formed on a back side 101b of the substrate 101. In another embodiment, the scribing portion 102 is formed on a front side 101a of the substrate 101 or at any other place of the substrate 101. In this embodiment, the scribing portion 102 is formed after the cover layer 105 and the release film 107 have been affixed to the substrate 101 (described in detail later.)

Referring to FIG. 2, the circuit antenna 103 is formed on the front side 101a of the substrate 101. In this embodiment, the circuit antenna 103 is preferably made of copper and is 10˜30 μm thick. In another embodiment, the circuit antenna 103 is made of any other appropriate material, such as a silver paste. The silver paste is a conductive adhesive which is a composite material produced from a synthetic resin functioning as a cementing agent and silver powder functioning as filler. After a period of time of use, especially when exposed to sunlight for a long period of time, the cementing agent is susceptible to aging, and thus the distribution of the silver powder in the cementing agent is no longer uniform, thereby causing the silver paste to lose its electrical conductivity gradually. As a result, the embodiment in which the silver paste is in use is applicable to radio frequency identification tags with a short service life. In this regard, copper is not confronted with the aforesaid silver paste-related problem and thus has a service life for several years. Factors in choosing the material which the circuit antenna 103 is made of include electrical conductivity, service life, and feasibility of its manufacturing process. To prevent reuse, the substrate 101 of the present invention must be made of a brittle material, and thus its manufacturing process includes a step of averting a press while the circuit antenna 103 is being formed on the substrate 101. For this reason, a conventional manufacturing process which involves adhering a copper sheet to the substrate 101 by performing a hot-pressing step with an adhesive, is inapplicable to the present invention. To effectuate the present invention, it is necessary to form the circuit antenna 103 by producing conductive patterns in a sputtering process or in a conventional press-free circuit board manufacturing process, such as wet film, printing, or baking.

Referring to FIG. 2, in addition to the circuit antenna 103, the substrate 101 comprises the chip 109. In this embodiment, the chip 109 is preferably a packaged chip. For further details of the structure and manufacturing method of the chip 109, refer to Taiwan Patent Application 97120461 whose contents are included herein. The embodiments of the present invention also apply to chips with any other structures. In this regard, appropriate prior art, such as soldering or any other appropriate technique, is effective in fixing the chip 109 to the substrate 103 and electrically connecting the chip 109 to the circuit antenna 103.

Referring to FIG. 2, after forming the circuit antenna 103 and fixing the chip 109 to the substrate 101, it is necessary to dispose the cover layer 105 and the release film 107 on the substrate 101 to enclose the circuit antenna 103 and the chip 109. The cover layer 105 is either monolayered or multilayered and is made of polyimide, polyethylene terephthalate (PET), any other appropriate material, or various combinations thereof. The cover layer 105 not only protects the circuit antenna 103 and the chip 109 but also assists the radio frequency identification tag 100 in generating appropriate curvature. The cover layer 105 is further coated with an adhesive so as for the cover layer 105 to have an adhesive surface 105a for providing appropriate adhesiveness required to adhere the cover layer 105 to the surface of a target object. Depending on the target object, the adhesive is a rubber adhesive, an acrylic adhesive, a hot-melt adhesive, or an AB adhesive. The release film 107 insulates the adhesive surface 105a from the outside temporarily to facilitate the transport and operation of products. The release film 107 is a conventional PET film coated with a release agent. The release agent is a silicon release agent or non-silicon release agent.

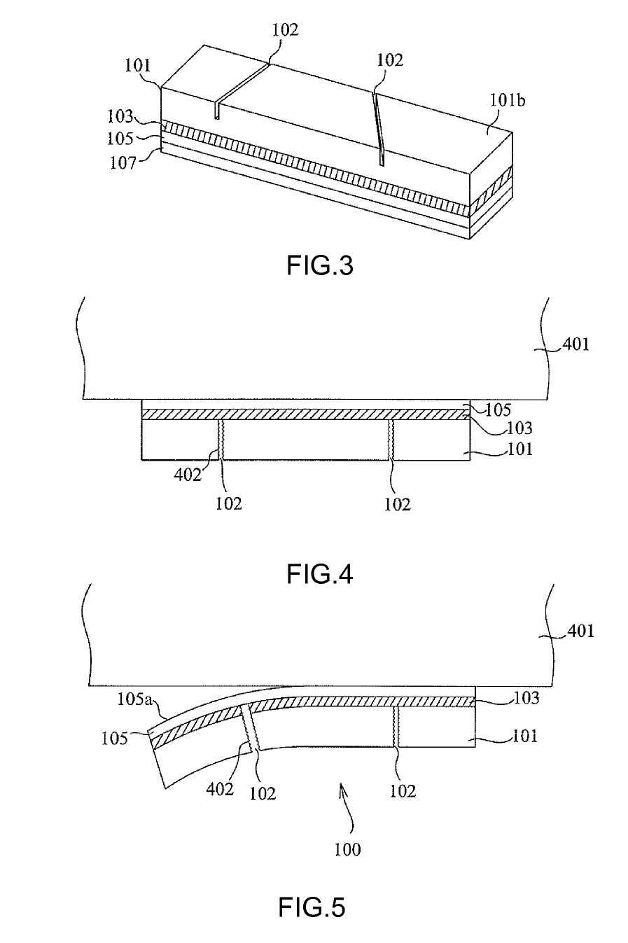

Referring to FIG. 3, after disposing the cover layer 105 and the release film 107 on the substrate 101, it is necessary to turn over the resultant product in order to form therein the scribing portion 102. It is important that a rupture surface, which forms when the substrate 101 ruptures along the at least a scribing portion 102, can press the circuit antenna 103 readily; to this end, the at least a scribing portion 102 preferably lies above the wiring distribution region of the circuit antenna 103. When viewed from the back 101b of the substrate 101, at least one part of the scribing portion 102 covers at least a portion of the circuit antenna 103. Hence, when viewed from the back side 101b of the substrate 101, the part of scribing portion 102 overlaps at least a portion of the circuit antenna 103. FIG. 3 shows two linear scribing portions 102; however, in another embodiment, the scribing portion 102 is in the number of one or more than two. The patterns of the at least a scribing portion 102 are not limited to linear patterns but include curved patterns and any other appropriate patterns. The tool selected for forming the scribing portion 102 depends on the material which the substrate 101 is made of. In case the substrate 101 is made of glass, the forming tool may be a diamond cutter or a tungsten steel cutting wheel. In case the substrate 101 is made of ceramics, the forming tool may be a laser cutter. The depth of the scribing portion 102 depends on the characteristics of the substrate 101 and is determined on the basis of criteria as follows: the substrate 101 of the radio frequency identification tag 100 ruptures along the scribing portion 102 without weakening the structure of the circuit antenna 103 into the level of failure, as soon as an user presses the radio frequency identification tag 100 to affix it to an object. In a variant embodiment, the rupture of the scribing portion 102 leads to the slight weakening of the structure of the circuit antenna 103, but this embodiment will be in the scope of the present invention provided that the circuit antenna 103 does not fail by the slightly weaken structure.

FIG. 4 is a schematic view of the radio frequency identification tag 100 affixed to an external object 401 according to the present invention. As shown in the diagram, the user removes the release film 107 and then affixes the adhesive surface 105a of the radio frequency identification tag 100 to the surface of the external object 401. To attain satisfactory connection between the radio frequency identification tag 100 and the surface of the external object 401, the user presses the radio frequency identification tag 100 by exerting thereon a force; meanwhile, the substrate 101 of the radio frequency identification tag 100 ruptures along the scribing portion 102 under the force, thereby forming a rupture surface 402. If the substrate 101 does not rupture, the user may exert a force on the radio frequency identification tag 100 again to cause the substrate 101 of the radio frequency identification tag 100 to rupture. The substrate 101 is likely to generate a sound when it ruptures, and thus the user can determine whether the substrate 101 has ruptured by perceiving the sound. At this point in time, although the substrate 101 has ruptured, the structure of the circuit antenna 103 has not weakened severely enough to fail; hence, the radio frequency identification tag 100 is still functioning well.

FIG. 5 is a schematic view of the radio frequency identification tag 100 being removed from the external object 401 by the user. As shown in the diagram, when the user peels the radio frequency identification tag 100 from the external object 401, the rupture surface 402 which forms along the scribing portion 102 of the substrate 101 damages the circuit antenna 103 to cause the radio frequency identification tag 100 to fail. To ensure the peeling process will cause the circuit antenna 103 to fail, it is practicable to adjust the thickness of the circuit antenna 103 appropriately. If the circuit antenna 103 is too thick, the peeling process will weaken the structure of the circuit antenna 103 but will not necessarily cause the circuit antenna 103 to fail. If the circuit antenna 103 is too thin, the peeling process will weaken the structure of the circuit antenna 103 and cause the circuit antenna 103 to fail, but the overly thin circuit antenna 103 in operation will be flawed with reduced reliability. Another technique of causing the circuit antenna 103 to fail by the peeling process is as follows: increasing the adhesiveness strength of the adhesive surface 105a toward the external object 401. The technique requires the user to exert a larger force in order to peel off the radio frequency identification tag 100, such that the ability of the rupture surface 402 to damage the circuit antenna 103 increases greatly.

FIGS. 1-4 show that, in this embodiment of the present invention, the radio frequency identification tag 100 comprises the substrate 101, the circuit antenna 103, the chip 109, the cover layer 105, and the release film 107. In another embodiment of the present invention, the radio frequency identification tag 100 further comprises any other components, such as a protective film (not shown) affixed to the back 101b of the substrate 101 to conceal the scribing portion 102. The protective film is made of a material which is tough and printable, such as PET film.

The radio frequency identification tags of the present invention apply to a management system based on radio frequency identification technology. The management system comprises the radio frequency identification tag 100, RFID reader/writer, and information processing device. Given a wireless radio frequency signal, the RFID reader/writer reads and decodes specific information carried by the radio frequency identification tag 100, and then the decoded specific information is sent to the information processing device for further application and management. The application of the management system includes various sorts of parking fee payment management, highway toll management, and vehicle exit & entrance surveillance management.

FIG. 1 through FIG. 5 is illustrative of the radio frequency identification tag according to a preferred embodiment of the present invention, the present invention further includes various embodiments described above and any other embodiments. The embodiments are illustrative rather than restrictive of the present invention. All equivalent changes and modifications accomplished without departing from the spirit embodied in the present invention must fall within the appended claims.

What is claimed is:

1. A radio frequency identification tag, comprising:
a chip;
a circuit antenna connected to the chip; and
a substrate having a front side carrying the chip and the circuit antenna and having a scribing portion, wherein the scribing portion overlaps at least one part of the circuit antenna when viewed from a back side of the substrate.

2. The radio frequency identification tag of claim 1, wherein, when the radio frequency identification tag is affixed to an object, the radio frequency identification tag is pressed to cause the substrate to rupture along the scribing portion but without causing the circuit antenna to fail.

3. The radio frequency identification tag of claim 2, wherein, when the radio frequency identification tag is peeled from the object under an applied force, a rupture surface which forms along the scribing portion of the substrate weakens the circuit antenna to cause the radio frequency identification tag to fail.

4. The radio frequency identification tag of claim 1, wherein the circuit antenna is made of copper.

5. The radio frequency identification tag of claim 4, wherein the circuit antenna is 10˜30 μm thick.

6. The radio frequency identification tag of claim 1, wherein the substrate is made of glass.

7. The radio frequency identification tag of claim 1, wherein the substrate is 0.45˜1.00 mm thick.

8. The radio frequency identification tag of claim 1, wherein the scribing portion is formed on the back side of the substrate.

9. The radio frequency identification tag of claim 1, further comprising a protective film affixed to the back side of the substrate to conceal the scribing portion.

10. A management system based on radio frequency identification technology, comprising the radio frequency identification tag of claim 1.
